(19) United States
(12) Patent Application Publication
(10) Pub. No.: US 2007/0106459 A1
(43) Pub. Date: May 10, 2007

(54) Route navigation systems, methods and programs

(75) Inventors: Takaaki Nakayama, Okazaki (JP); Shino Oonishi, Okazaki (JP); Kensuke Takeuchi, Okazaki (JP)

Correspondence Address: OLIFF & BERRIDGE, PLC, P.O. BOX 19928, ALEXANDRIA, VA, 22320, US

(73) Assignee: AISIN AW CO., LTD., ANJO-SHI (JP)

(21) Appl. No.: 11/589,901

(22) Filed: Oct. 31, 2006

(30) Foreign Application Priority Data
Oct. 31, 2005 (JP) 2005-317434
Nov. 30, 2005 (JP) 2005-346662

(51) Int. Cl. G01C 21/00

(52) U.S. Cl. 701/201; 701/210

(57) ABSTRACT

Route guidance systems, methods, and programs detect the current location of a vehicle and search for a route to a destination. The systems, methods, and programs set a guidance intersection based on the searched route and determine whether an assistant guidance intersection exists on the searched route, the assistant guidance intersection having a parallel road which extends in the same direction as a departing road from the guidance intersection. The systems, methods, and programs perform guidance for leading the vehicle to the departing road when the vehicle approaches the guidance intersection after having passed the assistant guidance intersection.

The disclosure of Japanese Patent Application No. 2005-317434 filed on Oct. 31, 2005 and No. 2005-346662 filed on Nov. 30, 2005, including the specification, drawings and abstract thereof, is incorporated herein by reference in its entirety.

### BACKGROUND

Related technical fields include route guidance systems, methods and programs.

Conventional navigation systems detect the current location of a and read out map data from a data recording unit. A map screen is displayed on a display unit with the current location of the vehicle. Accordingly, a driver can drive a vehicle in accordance with the vehicle location displayed on the map screen.

Upon the driver inputting a destination and setting search conditions, route-searching is performed based on the search conditions. A route from a departing location to the destination is searched in accordance with the map data. Subsequently, the route is displayed on the map screen together with the vehicle location, and route guidance is performed. Accordingly, the driver can drive the vehicle along the displayed searched route.

During route guidance, audio is output to perform route guidance in the event that it is necessary to turn the vehicle at a predetermined intersection before the vehicle reaches the intersection. Accordingly, one or more route guidance spots are set at predetermined distances before the guidance intersection on the searched route, and upon the vehicle reaching each of the route guidance spots, audio is output (e.g., see Japanese Unexamined Patent Application Publication No. 6-295399).

### SUMMARY

However, in a case where a road extending in the same direction as the departing road comes to an intersection before the guidance intersection on the searched route, the driver may erroneously recognize the intersection as the guidance intersection. Accordingly, the vehicle cannot be driven reliably according to the searched route.

Accordingly, exemplary implementations of the broad principles described herein provide assistance for drivers wherein a vehicle can be driven reliably according to a searched route.

Exemplary implementations provide route guidance systems, methods and programs that may detect the current location of a vehicle and may search for a route to a destination. The systems, methods, and programs may set a guidance intersection based on the searched route and may determine whether an assistant guidance intersection exists on the searched route, the assistant guidance intersection having a parallel road which extends in the same direction as a departing road from the guidance intersection. The systems, methods, and programs may perform guidance for leading the vehicle to the departing road when the vehicle approaches the guidance intersection after having passed the assistant guidance intersection.

According to an exemplary implementation, a vehicle may be guided to the departing road when the vehicle approaches the guidance intersection after having passed the assistant guidance intersection. Thus, the driver may not erroneously recognize the assistant guidance intersection as the guidance intersection and turn the vehicle. As a result, a driver may reliably drive the vehicle along the searched route.

### BRIEF DESCRIPTION OF THE DRAWINGS

Exemplary implementations will now be described with reference to the accompanying drawings, wherein:

FIG. 1 is a diagram illustrating an exemplary navigation system;

FIG. 2 is a flowchart showing an exemplary voice output method;

FIG. 3 is a diagram showing an exemplary parallel road;

FIG. 4 is a diagram showing an exemplary parallel road;

FIG. 5 is a diagram showing an exemplary parallel road;

FIG. 6 is a diagram showing an exemplary parallel road;

FIG. 7 is a diagram showing exemplary voice output;

FIG. 8 is a diagram showing exemplary voice output; and

FIG. 9 is a diagram showing exemplary voice output.

### DETAILED DESCRIPTION OF EXEMPLARY IMPLEMENTATIONS

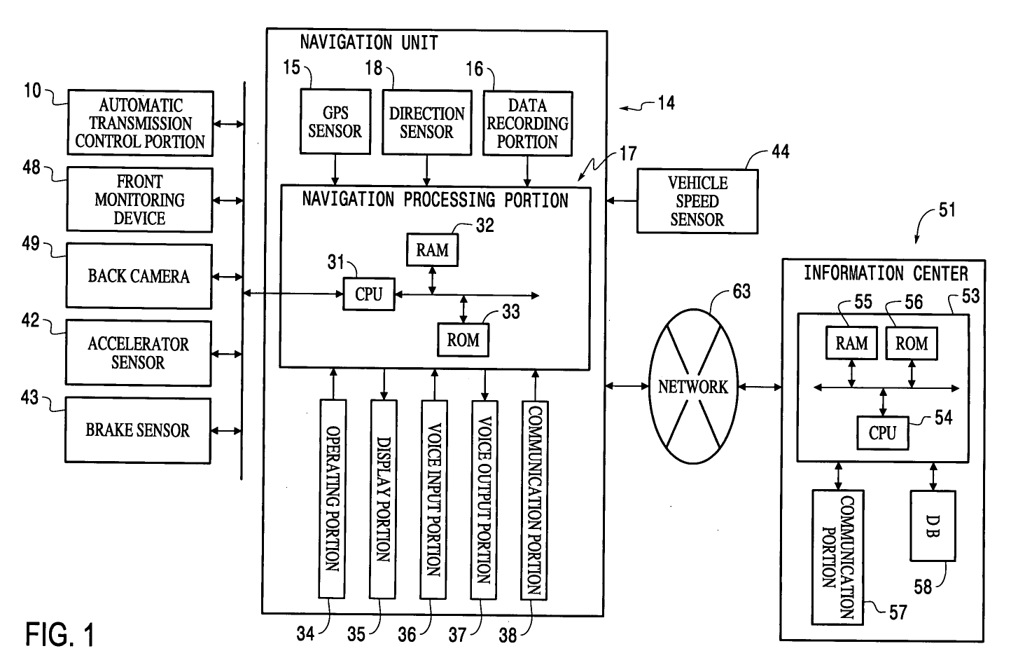

FIG. 1 is a diagram illustrating an exemplary navigation system. In the diagram, reference numeral 10 may denote an automatic transmission control unit serving as a power train control unit, in which this automatic transmission control unit 10 performs control for a power train performing gear shifting at a predetermined gear shifting ratio, for example, a Continuously Variable Transmission (CVT) serving as a non-step transmission, a stepped transmission (automatic transmission), an electric drive device, and so forth.

Reference numeral 14 may denote an information terminal, for example, a navigation device serving as an on-board device mounted on a vehicle. Reference numeral 63 may denote a network, and reference numeral 51 may denote an information center serving as an information provider. The navigation system may include, for example, the automatic transmission control 10, navigation device 14, network 63, information center 51, and so forth.

The navigation device 14,may include, for example, a GPS sensor 15, a memory (e.g., a data recording unit 16) serving as an information recording unit wherein various information other than map data is recorded, a controller (e.g., a navigation processing unit 17) for performing various computations such as navigation computations or the like based on input information, a direction sensor 18 serving as a direction detecting unit which detects the direction of the vehicle, an operating unit 34 serving as an input unit for allowing the operator to serve as an operator to perform predetermined input, a display unit 35 serving as an output unit for performing various types of display by images displayed on a screen, a voice input unit 36 serving as an input unit for allowing the operator to perform predetermined input by voice, a voice output unit 37 serving as an output unit for notifying the driver by audio, and a communication unit 38 serving as a transmitting/receiving unit which functions as a communication terminal. The GPS sensor 15, data recording unit 16, direction sensor 18, operating unit 34, display unit 35, voice input unit 36, voice output unit 37, and communication unit 38 may be connected, for example, to the navigation processing unit 17.

Also, the navigation processing unit 17 may be connected to the automatic transmission control unit 10, a front monitoring device 48 which may be attached to a predetermined location on the front end of the vehicle and may be for monitoring the front of the vehicle, a back camera (rear monitoring camera) 49 which may be attached to a predetermined location on the rear end of the vehicle, which may serve as an image-capturing device for photographing and monitoring the rear of the vehicle, an accelerator sensor 42 serving, for example, to detect the operation of the accelerator pedal by the driver with the degree of opening of the accelerator, a brake sensor 43 serving for example, to detect the operation of the brake pedal by the driver with the amount of brake-stepping, a vehicle speed sensor 44 serving for example, to detect the vehicle speed S, and so forth. The accelerator sensor 42, brake sensor 43 and so forth may make up the operating information detecting unit for detecting operating information of the vehicle by the driver.

The GPS sensor 15 may detect the current location on Earth by receiving radio waves generated by a satellite, and also may detect the time of day. In an exemplary implementation a GPS sensor 15 may be used as the current location detecting unit, but instead of this GPS sensor 15, a distance sensor, steering sensor, altimeter and so forth can be used individually or in combination. A gyro sensor, geomagnetic sensor or the like can be used as the direction sensor 18. In an exemplary implementation, a direction sensor 18, vehicle speed sensor 44, and so forth may be provided, but in the case of using a GPS sensor which has a function for detecting vehicle direction, vehicle speed, and so forth, the direction sensor 18, vehicle speed sensor 44, and so forth may not be needed.

The data recording unit 16 may have a map database made up of map data files, and map data may be recorded into this map database. This map data may include, for example, intersection data relating to intersections, node data relating to nodes, road data related to road links, search data which is processed for searching, and facility data relating to facilities, as well as object feature data relating to object features on the road.

As used herein, the term “link” refers to, for example, a road or portion of a road. For example, according to one type of road data, each road may consist of a plurality of componential units called links. Each link may be separated and defined by, for example, an intersection, an intersection having more than three roads, a curve, and/or a point at which the road type changes. As used herein the term “node” refers to a point connecting two links. A node may be, for example, an intersection, an intersection having more than three roads, a curve, and/or a point at which the road type changes.

The object features may be displayed objects installed or formed on roads for providing various types of information to a driver, and may include display lines, road signs, pedestrian crossings, manholes, traffic signals, and so forth. The display lines may include stop lines for stopping vehicles, vehicular lane borderlines for classifying each lane, compartment lines indicating parking spaces, and so forth. The road signs may include traffic classification signs indicating the traveling direction of each lane using an arrow, and guidance signs for announcing a temporary stop spot beforehand, such as “STOP” and so forth. The object feature data may include positional information wherein the position of each object feature is represented with coordinates or the like, image information wherein each object feature is represented with an image, and so forth. The temporary stop spot may include entrance spots to a preferential road from a non-preferential road, railroad crossings, intersections where a red signal flashes, and so forth.

The road data regarding the above-mentioned lanes may include lane data made up of lane numbers assigned for each lane on a road, lane position information, and so forth. Data for outputting predetermined information using the voice output unit 37 may also be recorded in the data recording unit 16.

Further, with the data recording unit 16, a statistical database made up of statistical data files, a driving history database made up of driving history data files, and so forth may be formed. Statistical data may be recorded in a statistical data file, and driving history data may be recording in a driving history data file, either of which is recorded as record data.

The statistical data may be record traffic information provided in the past, i.e., history information or the like such as the VICS (Vehicle Information and Communication System) center or the like serving as an informant, road traffic census information indicating traffic volume using the road traffic. census provided by the Ministry of Land, Infrastructure and Transport, the road time-table information provided by the Ministry of Land, Infrastructure and Transport, and so forth independently, or in combination, and subjecting those to refining and statistical processing as necessary. Note that the statistical data can be added with heavy traffic forecast information for forecasting heavy traffic situations, and so forth. In this case, when creating the statistical data, detailed conditions such as date and time, day of the week, weather, various types of events, season, information of facilities (existence of large-sized facilities such as a department store, supermarket, and so forth), and so forth may be added to the history information.

The statistical data may include a link number regarding each of road links, a direction flag indicating the direction of travel, an information classification indicating the type of information, the degree of heavy traffic for predetermined timing, link duration indicating duration for each predetermined timing when traveling along each of the road links, average data for every day of the week of the link duration and so forth.

Also, the driving history data, which may be collected from multiple vehicles, i.e., a vehicle or the other vehicles by the information center 51, may be record information indicating the vehicle driving record in the roads where each of the vehicles ran, and may be calculated as probe data based on driving data, and may be accumulated.

Driving history data includes, for example, link duration for each predetermined timing when traveling along each of the road links, the degree of heavy traffic for each predetermined timing when traveling along each of the road links, and so forth. The statistical data can be added with the driving history data. Also, in an exemplary implementation, the degree of heavy traffic is used as a heavy traffic index indicating the degree of heavy traffic, which may be classified into heavy traffic, congestion, and light traffic.

The data recording unit 16 may include disks such as a hard disk, CD, DVD, optical disc, and so forth to record the various types of data, and also may include heads such as read/write head for reading or writing various types of data, and so forth. Also, with the data recording unit 16, a memory card or the like can be used. Each of the disks, memory card, and so forth may make up an external storage device.

In an exemplary implementation, the map database, statistical database, driving history database, and so forth may be arranged to be formed in the data recording unit 16, but the map database, statistical database, driving history database, and so forth can be formed in the information center 51.

Also, the navigation processing unit 17 may include a CPU 31 serving as a control device for controlling the entirety of the navigation device 14, and also serving as a computing device, RAM 32 which is used as working memory when the CPU 31 performs various types of computing processing, ROM 33 in which various types of programs for performing route searching and route guidance as well as a control program may be contained, and flash memory which is used to record various types of data, programs, and so forth. Note that the RAM 32, ROM 33, flash memory, and so forth may make up an internal storage device.

In an exemplary implementation, various types of programs can be recorded in the ROM 33, and various types of data can be recorded in the data recording unit 16, but the programs, data, and so forth can be recorded in a disk or the like. In this case, the programs, data, and so forth can be read out from the disk or the like to be written in the flash memory. Accordingly, the programs, data, and so forth can be updated by replacing the disk or the like. Also, the control program, data, and so forth of the automatic transmission control unit 10 can be recorded in the disk or the like. Also, a program, data, and so forth for control by the automatic transmission control unit 10 can be recorded on the disk and so forth. Further, the program, data, and so forth can be also received via the communication unit 38 to be written in the flash memory of the navigation processing unit 17.

The operating unit 34 may be for correcting the current location at the time of start of traveling, inputting a departure location and a destination, inputting passing points, and activating the communication unit 38 by the driver operating the operating unit 34. A keyboard, mouse, and so forth, which may be disposed independently from the display unit 35, can be used as the operating unit 34. A touch panel, which may enable predetermined input operations by touching or clicking an image on the display unit 35 may be used as the operating unit 34.

A display may be used as the display unit 35. On various types of screens formed on the display unit 35, the direction of a vehicle can be displayed as a vehicle direction with the current location of a vehicle, a map, a searched route, the guidance information along the searched route, traffic information, the distance up to the next intersection in the searched route, and the progressive direction at the next intersection can be displayed. Additionally, the operating guidance, operating menu, and key guidance of the image operating unit, operating unit 34, voice input unit 36, the program of an FM multiplex broadcast, and so forth can be displayed.

The voice input unit 36 may include a microphone, whereby necessary information can be input by voice. Further, the voice output unit 37 may include a voice synthesizer and speakers. The searched route, guidance information, traffic information, or the like may be output from the voice output unit 37, for example, by the voice synthesizer.

The communication unit 38 includes, for example, a beacon receiver for receiving various types of information such as the current traffic information, common information transmitted from the road traffic information center via an electric-wave beacon device, an optical beacon device, an FM receiver, and the like. The traffic information may include, for example, heavy traffic information, restriction information, parking information, traffic accident information, the congestion status information of a rest area, and so forth. The common information includes news, weather forecasts, and so forth. The beacon receiver and FM receiver may be arranged so as to be unitized and disposed as a VICS receiver, but can be disposed separately.

The traffic information may include an information, a mesh number for identifying mesh, a link number for pinpointing a road link connecting between two spots, the classification of roads, and link information indicating the content of the information to be provided corresponding to the link number. For example, in the event that the traffic information is heavy traffic information, the link information may include heavy traffic head data indicating the distance from the start point of the road link to the head of heavy traffic, the degree of heavy traffic, heavy traffic length (i.e., the distance from the head of the road link to the end of heavy traffic), link duration, and so forth.

The communication unit 38 can receive various types of information such as, for example, traffic information, common information from the information center 51 via the network 63, as well as data such as the map data, statistical data, driving history data, and so forth.

Accordingly, the information center 51 may include a server 53, a communication unit 57 connected to the server 53, a database (DB) 58 serving as an information recording unit, and so forth. The server 53 may include a CPU 54 serving as a control device, and also serving as a computing device, RAM 55, ROM 56, and so forth. Also, the same data as the various data recorded in the data recording unit 16, e.g., the map data, statistical data, driving history data, and so forth may be recorded in the database 58. Further, the information center 51 may provide various types of information such as the current traffic information, common information transmitted, for example, from the road traffic information center, and driving history data collected from multiple vehicles (vehicle and other vehicles) in real time.

The front monitoring device 48 may include a laser radar, a radar such as a millimeter-wave radar, an ultrasonic sensor, or a combination of those, or the like. The front monitoring device 48 may monitor a preceding vehicle and temporary stop spots and obstacles. Also, the front monitoring device 48 may detect relative vehicle speed as to the preceding vehicle, approach speed as to a temporary stop spot, approach speed for obstacles, and so forth, and may calculate the distance between vehicles, inter vehicle time, and so forth.

The back camera 49 may be made up of a CCD device, which may be attached in a state in which the optical axis is directed diagonally downward in order to capture data regarding the vehicles traveling behind the vehicle, buildings and structures of the road side, and so forth as photographed objects as well as object features. The back camera 49 then generates the image data of the photographed objects which were photographed and may transmit them to the CPU 31. The CPU 31 may read in the image data, and recognize the respective photographed objects within the image as objects to be recognized by subjecting the image data to image processing. In an exemplary implementation, a CCD device is used as the back camera 49, but a CMOS device or the like can be used.

The navigation system, navigation processing unit 17, CPU 31, CPU 54, server 53, and so forth may serve as a computer by being used independently, or in combination of two or more, and may perform computing processing based on various types of programs, data, and so forth. The data recording unit 16, RAM 32, RAM 55, ROM 33, ROM 56, database 58, flash memory, and so forth may make up a recording medium. An MPU or the like can be also used instead of the CPU 31 and CPU 54 as a computing device.

Next, a description will be made regarding the basic operation of the navigation system having the above configuration.

First, a driver may activate the navigation device 14, and the CPU 31 may perform navigation initializing,, read in the current location of the vehicle detected by the GPS sensor 15, the vehicle direction detected by the direction sensor 18, and also initialize various types of data. Next, the CPU 31 may perform matching, and may pinpoint the current location by determining whether the current location is positioned on a road link based on the course of the current location that has been read in and the shapes and array of the respective road links making up the roads around the current location.

In an exemplary implementation, the CPU 31 pinpoints the current location based on the positions of the respective object features photographed by the back camera 49.

Accordingly the CPU 31 may perform image recognition read in image data from the back camera 49, and may recognize the object features within the image. Also, the CPU 31 may the distance from the back camera 49 to the actual object feature based on the position of the object feature within the image. Subsequently, the CPU 31 may perform current-location pinpointing to read in the distance, and also read out the object data to obtain the coordinates of the object feature, and may pinpoint the current location based on the obtained coordinates and distance.

Also, the CPU 31 may detect the lane where the vehicle is traveling by comparing the object feature recognized based on the image data with the object feature read out from the data recording unit 16.

Note that the CPU 31 may read in the sensor output of the magnetic-field sensor, and determine whether or not there is a detected object made up of ferromagnetic material such as a manhole or the like on a predetermined lane on a road, whereby the driving lane can also be detected based on the result. Further, the current location may be detected by using a high-precision GPS sensor 15, whereby the current location can be detected precisely and the driving lane can be detected based on the detection result. While subjecting the image data of display lines to image processing, the sensor output of the magnetic-field sensor, the current location, and so forth are combined as necessary, whereby the driving lane can be detected.

Subsequently, the CPU 31 may obtain the map data by reading out the map data from the data recording unit 16, or by receiving the map data from the information center 51 or the like via the communication unit 38. In the event of obtaining the map data from the information center 51 or the like, the CPU 31 may download the received map data to the flash memory.

Subsequently, the CPU 31 may form various types of screens on the display unit 35. For example, the CPU 31 may form a map screen on the display unit 35, may display the surrounding map on the map screen, and also may display the direction of a vehicle. Accordingly, the driver can drive the vehicle in accordance with the map, vehicle location, and/or the vehicle direction.

Also, the CPU 31 may set a destination. Note that a departure location can be input and set as necessary. Also, a predetermined spot can be registered beforehand, and the registered spot can be set as a destination. Subsequently, the CPU 31 may set searching conditions.

Thus, upon the destination and searching conditions being set, the CPU 31 may perform route-searching to read in the current location, destination, and searching conditions, may read out the search data from the data recording unit 16; may search the route from the departure location, destination, and search data; and may output the route data indicating a searched route. At this time, the route wherein the sum of the link costs is the smallest may be taken as a searched route.

Also, in the case wherein multiple lanes are formed on the road, and also in the case of the driving lane being detected, the CPU 31 may search the search route with a lane as a unit. In this case, lane numbers of the driving lanes and so forth may be also included in the route data.

Note that route searching processing can be performed at the information center 51. In this case, the CPU 31 may transmit the current location, destination, searching conditions, and so forth to the information center 51. Upon the information center 51 receiving the current location, destination, searching conditions, and so forth, the CPU 54 may perform, as the CPU 31, and read out search data, search the route, search the destination, search data, and output the route data indicating a searched route. Next, the CPU 54 may transmit the route data to the navigation device 14.

Subsequently, the CPU 31 may perform route guidance. Accordingly, the CPU 31 may display the searched route on the map screen in accordance with the route data.

With the route guidance, in the case that it is necessary to turn the vehicle at a predetermined intersection, the aforementioned intersection is set as a guidance spot and also as a guidance intersection. Therefore, the CPU 31 determines whether or not there is an intersection at which the vehicle must be turned, and in the case of an intersection at which the vehicle must be turned, this intersection is set as a guidance intersection.

Following this, and prior to the vehicle arriving at the guidance intersection, the CPU 31 may display an expanded view of the-guidance intersection at a predetermined region of the map screen and may perform route guidance with the intersection expanded view. In the case that the searched route is being searched with a lane as a unit, the CPU 31 may display the driving lane subjected to route guidance in the intersection expanded view, and performs route guidance with a lane as a unit. In this case, a map of the vicinity of the guidance intersection, the searched route, and landmarks such as facilities serving as a marker at the guidance intersection may be displayed on the intersection expanded view, and in the case of route guidance being performed with a lane as a unit, the driving lane may also be also displayed.

Also, the CPU 31 may set one or more route guidance spots at locations separated only a preset distance prior to (on the side of the current location of) the guidance intersection on the searched route. When a vehicle arrives at the various route guidance spots, route guidance regarding the guidance intersection is output by voice with content previously set for each route guidance spot. The intersection expanded view is displayed from the time of arrival at the first route guidance spot.

In the case where there is a road extending in the same direction as the departing road from the guidance intersection which has an intersection before the guidance intersection, the driver may erroneously recognize this intersection as the guidance intersection, and may turn the vehicle at the incorrect intersection.

Thus, the CPU 31 guides the driver of the vehicle so as to not erroneously recognize the intersection before the guidance intersection as the guidance intersection.

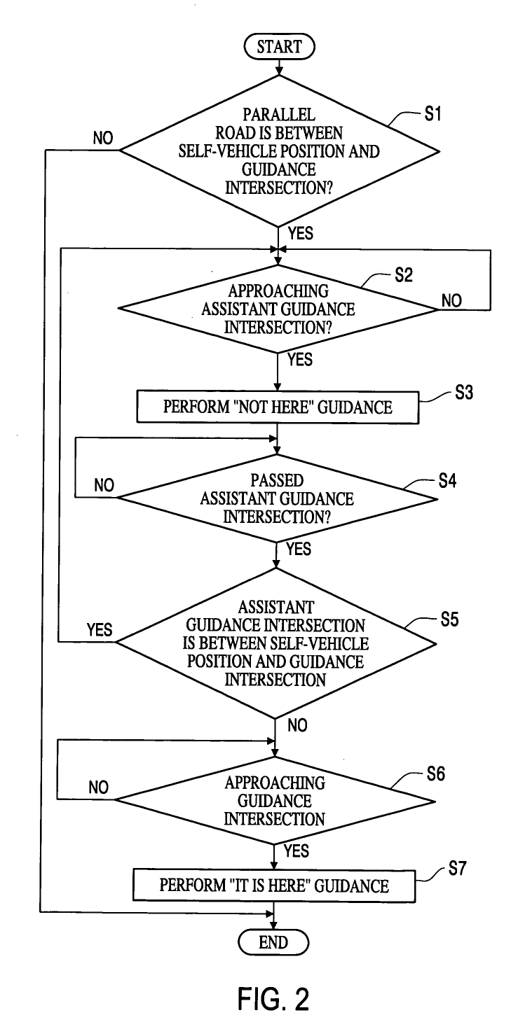

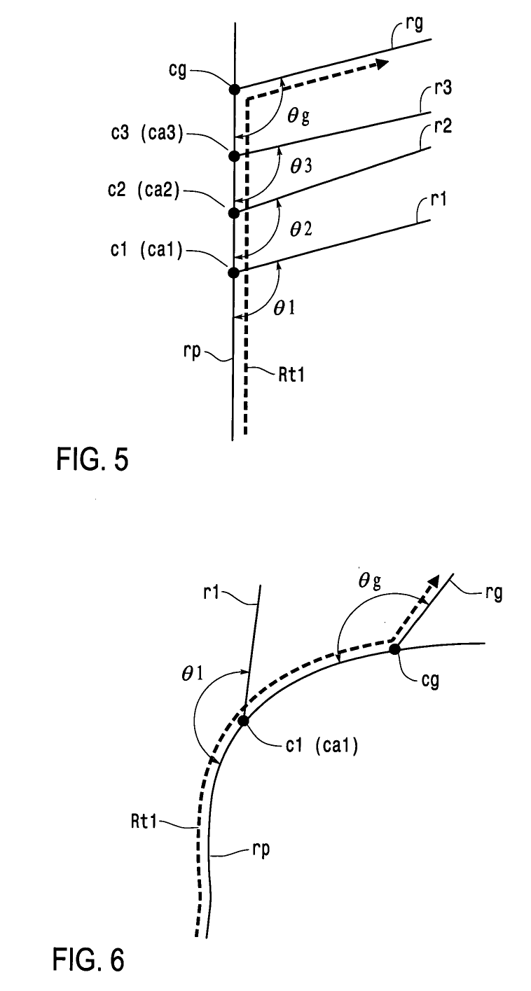

An exemplary voice output method will be described below with reference to FIGS. 2-6.

First, the CPU 31 may determine whether there is an intersection having a road, which a driver could erroneously recognize as the guidance intersection. Therefore, the CPU 31 reads out road data, intersection data, and the like from the data recording unit 16 (FIG. 1), and determines whether or not there is an intersection between the vehicle location and the guidance intersection. In the case there is an intersection, the CPU 31 may determine whether parallel road determining conditions will hold for each road extending in the same direction as the departing road from the guidance intersection of the searched route, for each intersection. In the case that the parallel road determining conditions will hold, the CPU 31 may determine that the applicable road is a parallel road.

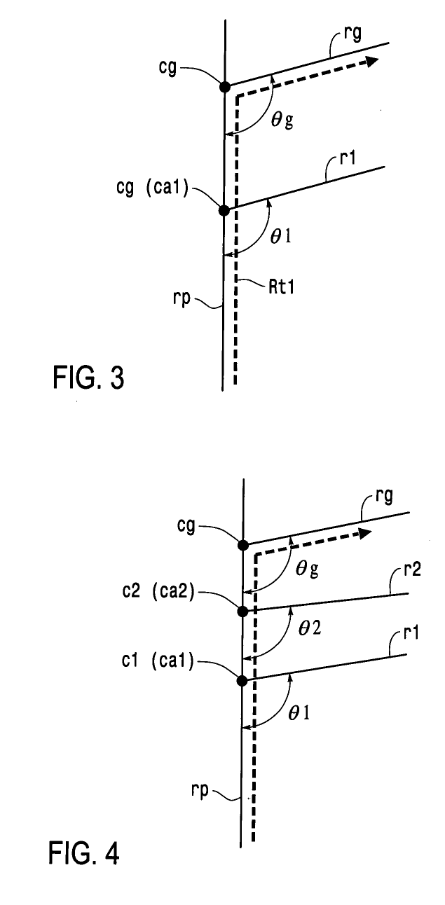

In FIGS. 3 through 6, Rt1 denotes the searched route, cg denotes the guidance intersection, ci (wherein i=1, 2, and so on) denotes an intersection between the vehicle location and the guidance intersection, rp denotes a road whereupon a vehicle is traveling and enters the intersection ci and the guidance intersection cg on the searched route Rt1, that is to say, the entrance road, rg denotes a departing road from the guidance intersection cg on the searched route Rt1, ri (wherein i=1, 2, and so on) denotes a connecting road which is connected to each intersection ci and which extends in the same direction as the departing road rg. In an exemplary implementation, in the case of the departing road rg extending in the direction of a right turn at the guidance intersection cg, the connecting road ri is set to extend in the direction of a right turn at each intersection ci, in the case of the departing road rg extending in the direction of a left turn, the connecting road ri is set to extend in the direction of a left turn at each intersection ci. Also, θg denotes the link angle showing the angle formed by the entrance road rp and departing road rg at the guidance intersection cg, and θi (wherein i=1, 2, and so on) denotes the link angle showing the angle formed by each entrance road rp and connecting road ri at each intersection ci. Note that with each intersection ci, the value of i becomes smaller for the distances closer to the vehicle position. Also, the various locations (coordinates) of the guidance intersection cg and intersections ci, θi, and so forth, are recorded as intersection data in the data recording unit 16.

First, the CPU 31 may calculate the intersection distance Li (wherein i=1, 2, and so on) showing the distance along the road from each intersection ci to the guidance intersection cg as a first determining indicator showing the relationship of the position of the intersection ci and the position of the guidance intersection cg, and calculates the road angle difference Δθi (wherein i=1, 2, and so on) according to the following equation (1)
Δθi=θg−θi (1)
as a function of the absolute value of the difference between the link angle θg and each link angle θi, as a second determining indicator showing the relationship of the link angle θg and each link angle θi.

Next, as a first condition, CPU 31 may determine whether or not the intersection distance Li is shorter than a threshold value Lth1. As a second condition, determination is made as to whether the road angle difference Δθi is smaller than the threshold δθth1. Also, in the case that the first and second conditions hold, the intersection distance Li is shorter than the threshold value Lth1, and the road angle difference Δθi is smaller than the threshold value δθth1, the CPU 31 may determine that the parallel road conditions hold, and determines that this road is a parallel road. Also, in the case that at least one of the first and second conditions do not fulfill the conditions, and the intersection distance Li is greater than the threshold value Lth1, or the road angle difference Δθi is greater than the threshold value δθth1, CPU 31 may determine the that parallel road conditions do not hold, and determines that the applicable road is not a parallel road. Note that instead of using the intersection distance Li, a direct distance from the intersections ci to the guidance intersection cg can be used as the first determining indicator, or instead of using the road angle difference Δθi, the ratio of each link angle qi as to the link angle Δθg can be used as the second determining indicator.

Subsequently, in the case CPU 31 may determine that the applicable road is a parallel road, the intersection corresponding to the parallel road out of the intersections ci is set the assistant guidance intersection caj (wherein j=1, 2, and so on), and calculates the distance Lmin between the vehicle location and the closest assistant guidance intersection, and determines whether or not the vehicle has approached the assistant guidance intersection caj, based on whether or not the distance Lmin is shorter than the threshold value Lth2.

Then, upon the vehicle approaching the assistant guidance intersection caj, the CPU 31 may perform guidance of “not here” serving as non-leading guidance, so as not to lead the vehicle erroneously, that is to say, so as not to let the driver enter the parallel road at the assistant guidance intersection caj.

Next, upon the vehicle passing through the assistant guidance intersection caj, CPU 31 may determine whether there is an assistant guidance intersection caj between the vehicle position and the guidance intersection cg, and in the case there is an assistant guidance intersection caj the CPU 31 performs “not here” guidance each time the vehicle approaches the nearest assistant guidance intersection.

In an exemplary implementation, a determination is first made as to whether or not there is a parallel road between the vehicle position and the guidance intersection. In the case of multiple parallel roads between the vehicle position and the guidance intersection cg, the intersection -corresponding to each parallel road is set as the assistant guidance intersection caj, wherein non-leading guidance is performed sequentially for the assistant guidance intersections nearest the vehicle position. In the case of multiple parallel roads between the vehicle position and the guidance intersection cg, the intersections corresponding to the parallel road closest to the vehicle position are sequentially set as the assistant guidance intersections. Thus non-leading guidance can be performed for the various assistant guidance intersections.

Then, CPU 31 may calculate the distance Lg between the vehicle position and the guidance intersection cg, and determine whether the vehicle has approached the guidance intersection cg, based on whether the distance Lg is shorter than the threshold Lth3.

Then, when the vehicle approaches the guidance intersection cg, the CPU 31 may perform “turn here” guidance serving as leading guidance so as to lead the driver to turn the vehicle onto the departing road rg at the guidance intersecting cg.

The above-described method is summarized below with respect to FIG. 2. FIG. 2 is a flowchart showing an exemplary voice output method. The exemplary method may be implemented, for example, by one or more components of the above-described navigation system. However, even though the exemplary structure of the above-described navigation system may be referenced in the description, it should be appreciated that the structure is exemplary and the exemplary method need not be limited by any of the above-described exemplary structure.

Step S1: Determine whether or not there is a parallel road between the vehicle position and the guidance intersection cg.

Step S2: Standby to approach the assistant guidance intersection caj, and in the case of approaching, the flow proceeds to step S3.

Step S3: Perform “not here” guidance.

Step S4: Standby to pass through the assistant guidance intersection caj, and in the event of passing through the assistant guidance intersection caj, the flow proceeds to step S5.

Step S5: Determine whether or not there is an assistant guidance intersection caj between the vehicle position and the guidance intersection cg. In the case that there is an assistant guidance intersection caj between the vehicle position and the guidance intersection cg, the flow returns to step S2, and in the case there is no assistant guidance intersection caj, the flow proceeds to step S6.

Step S6: Standby to approach the guidance intersection cg, and in the case of approaching the guidance intersection cg, the flow proceeds to step S7.

Step S7: Perform “turn here” guidance and end the processing.

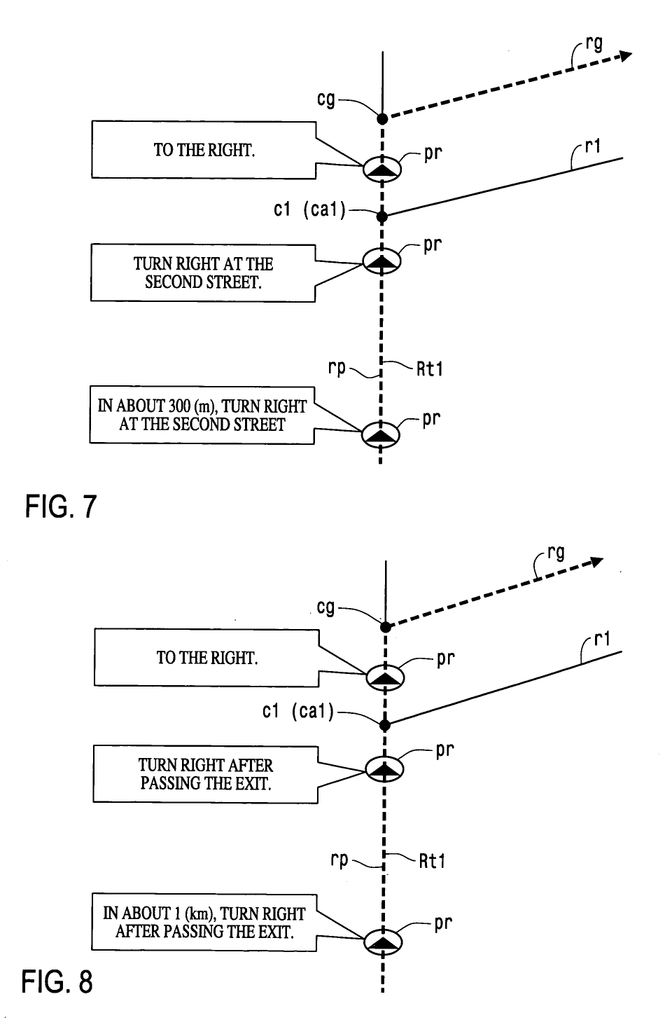

Next, exemplary voice output in the event of a parallel road such as that shown in FIGS. 7 and 8 will be described.

FIG. 7 is a diagram showing voice output, and FIG. 8 is a diagram exemplary voice output. In the drawings, Rt1 denotes the searched route, cg denotes the guidance intersection, c1 denotes an intersection between the vehicle position and the guidance intersection cg, rp denotes an entry road to the guidance intersection cg, rg denotes a departing road from the guidance intersection cg, r1 denotes a connecting road connected to the same side as the departing road rg at the intersection c1, and in this case, this connecting road r1 is a parallel road. Also, pr is a vehicle at the vehicle position.

In the example shown in FIG. 7, upon the vehicle pr arriving at a guidance point a predetermined distance, for example only X1 [m], from the guidance intersection cg, the CPU 31 may perform route guidance and voice output may occur with a message such as “In about 300 [m], turn right at the second street”. In this case, the CPU 31 may read the number of the intersection c1 between the vehicle position to the guidance intersection cg, and display the departing road rg from the guidance intersection cg as how many roads down, for example, “the second”.

Upon the vehicle pr approaching the intersection c1 serving as an assistant guidance intersection, the CPU 31 may perform “not here” guidance with the number of connecting roads ri from the vehicle position to the departing road rg, such as a message “it is the second street to the right”. Then upon the vehicle pr approaching the guidance intersection cg, the CPU 31 may perform “it is here” guidance with a message such as “turn to the right” for example.

Also, in the example shown in FIG. 8, upon the vehicle pr arriving at a guidance point a predetermined distance, for example only X1 [m], from the guidance intersection cg, the CPU 31 may output route guidance by voice with a message such as “In about 1 [km], pass the XX exit and turn in the right direction”. In this case, CPU 31 may read the information showing features of the intersection c1, which is between the vehicle position and the guidance intersection cg, and shows that the guidance intersection cg is further down from the intersection c1 as “pass the XX exit”.

Upon the vehicle pr approaching the intersection c1 serving as an assistant guidance intersection ca1, the CPU 31 may perform “not here” guidance with the features of the intersection c1, with a message such as “pass the exit and to the right”. Then, upon the vehicle pr approaching the guidance intersection cg, CPU 31 may perform “it is here” guidance with a message such as “it is in the right direction”, for example.

In an exemplary implementation, with the example shown in FIG. 7, the “not here” guidance is performed with the number of connecting roads ri from the guidance intersection cg to the departing road rg, but for example, can be performed with the number of intersections ci to the guidance intersection cg, such as a message of “turn right at the second intersection”. Also, in the event that the guidance intersection cg has a traffic signal but the assistant guidance intersection caj has no traffic signal, “not here” guidance can be performed according to whether there is a traffic signal, such as a message of “turn right at the intersection with a traffic signal”. Also, in the example shown in FIG. 8, the “not here” guidance can be performed with the features of the intersections c1 up to the guidance intersection cg, for example, the exits of a freeway.

Thus, in the case that there is a parallel road at a predetermined intersection before the guidance intersection cg on the searched route Rt1, upon the vehicle pr approaching the intersection, “not here” guidance is performed, and so the driver does not erroneously recognize the aforementioned intersection as the guidance intersection cg. Accordingly, the vehicle is not turned right or left at the intersection, and so the vehicle pr can be driven reliably along the searched route Rt1.

Also, “it is here” guidance and “not here” guidance is performed in coordination, and so the vehicle pr can be driven even more reliably along the searched route Rt1.

In an exemplary implementation, in the case of multiple assistant guidance intersections caj between the vehicle position and the guidance intersection cg, “not here” guidance is performed regarding each assistant guidance intersection caj, but an arrangement may be made wherein “not here” guidance is performed regarding the assistant guidance intersection nearest the vehicle position, and “not here” guidance is not performed on other assistant guidance intersections until approaching the guidance intersection cg.

In such a case, frequent voice output can be prevented, and so discomfort to the driver can be prevented. Also, in this case, showing “not here” guidance as the number of connecting roads ri from the vehicle position to the guidance intersection cg, the number of intersections ci to the guidance intersection cg, and so forth is desirable.

Now, with the various assistant guidance intersection caj, non-leading guidance can be performed in actuality by not performing guidance. Next, an exemplary implementation will be described, which has an arrangement wherein, upon the vehicle pr approaching the assistant guidance intersection caj, the vehicle pr is not led to the connecting road r1, but rather non-leading guidance is performed in actuality, and after the vehicle pr passes the assistant guidance intersection caj and approaches the guidance intersection cg, leading guidance is performed so as to lead the vehicle pr to the departing road rg.

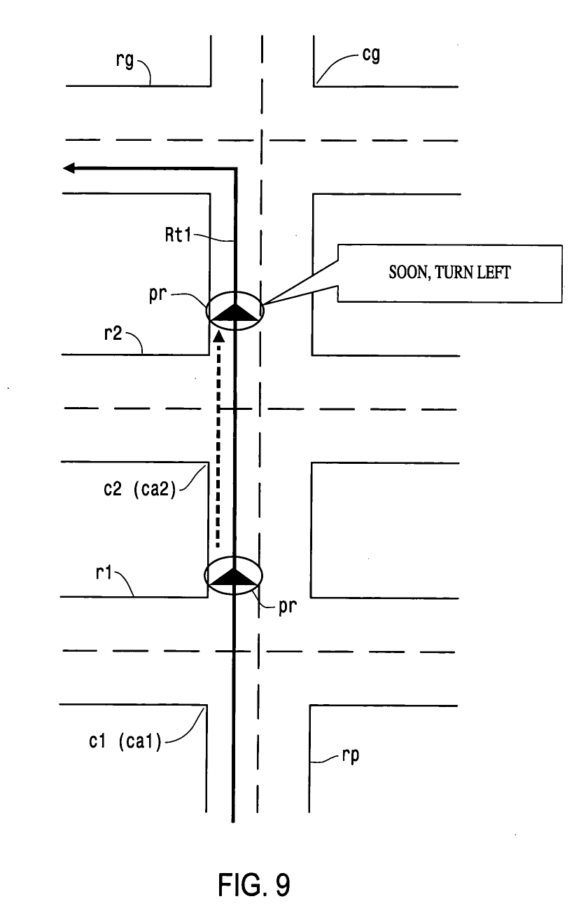

FIG. 9 is a diagram showing exemplary voice output. In this diagram, Rt1 denotes the searched route, cg denotes the guidance intersection, c1 and c2 denote intersections between the vehicle position and the guidance intersection cg, rp denotes an entrance road to the guidance intersection cg, rg denotes a departing road from the guidance intersection cg, r1 and r2 denote connecting roads connected on the same side as the departing road rg, and in this case, let us say that these connecting roads r1 and r2 are parallel roads. Also, pr denotes a vehicle in the vehicle position.

In an exemplary implementation, upon the vehicle pr approaching the intersection c1 and c2 serving as assistant guidance intersections ca1 and ca2, the CPU 31 may not lead the vehicle pr to the connecting roads r1 and dr2, and moreover, may not perform “not here” guidance. Accordingly, the CPU 31 performs non-leading guidance in actuality.

Following this, after the vehicle pr has passed the assistant guidance intersections ca1 and ca2 and approaches the guidance intersection cg, the CPU 31 may perform “it is here” guidance with a message such as “soon, turn to the left” or the like.

In this case, as shown in FIG. 9, the route guidance points are moved by the CPU 31, as shown with the dotted line arrows, until there are no more assistant guidance intersections ca1 and ca2.

Thus, in an exemplary implementation, with each assistant guidance intersections caj, non-leading guidance is performed in actuality by not performing any guidance, and since frequent voice output can be prevented, and thus discomfort to the driver can be prevented.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A route guidance system comprising:
a controller that:
detects the current location of a vehicle;
searches for a route to a destination;
sets a guidance intersection based on the searched route;
determines whether an assistant guidance intersection exists on the searched route, the assistant guidance intersection having a parallel road which extends in the same direction as a departing road from the guidance intersection; and
performs guidance for leading the vehicle to the departing road when the vehicle approaches the guidance intersection after having passed the assistant guidance intersection.

2. The route guidance system according to claim 1, wherein the controller:
determines whether there is a parallel road based on a relationship between the position of the intersection and the position of the guidance intersection.

3. The route guidance system according to claim 1, wherein the controller:
determines whether there is a parallel road based on a relationship between a linking angle formed by an entry road towards the guidance intersection and the departing road from the guidance intersection, and a linking angle formed by an entry road towards another intersection on the searched route and a road extending from the other intersection in the same direction as the departing road.

4. The route guidance system according to claim 1, wherein the controller:
performs non-leading guidance so as not to lead the vehicle to the parallel road when the vehicle approaches the assistant intersection in the event that there is the assistant guidance intersection.

5. The route guidance system according to claim 1, wherein the controller:
performs non-leading guidance at roads along the route from the current location to the departing road of the guidance intersection, the roads in the same direction as the departing road.

6. The route guidance system according to claim 1, wherein the controller:
performs non-leading guidance at intersections along the route from the current location to the guidance intersection.

7. The route guidance system according to claim 1, wherein the controller:
performs non-leading guidance with features of the assistant guidance intersection.

8. The route guidance system according to claim 1, wherein the controller:
performs non-leading guidance based on a presence or absence of traffic signal lights at the assistant guidance intersection and the guidance intersection.

9. The route guidance system according to claim 1, wherein the controller:
performs non-leading guidance by not performing leading guidance.

10. A route guidance method, comprising:
detecting the current location of a vehicle;
searching for a route to a destination;
setting a guidance intersection based on the searched route;
determining whether an assistant guidance intersection exists on the searched route, the assistant guidance intersection having a parallel road which extends in the same direction as a departing road from the guidance intersection; and
performing guidance for leading the vehicle to the departing road when the vehicle approaches the guidance intersection after having passed the assistant guidance intersection.

11. The route guidance method according to claim 10, further comprising:
determining whether there is a parallel road based on a relationship between the position of the intersection and the position of the guidance intersection.

12. The route guidance method according to claim 10, further comprising:
determining whether there is a parallel road based on a relationship between a linking angle formed by an entry road towards the guidance intersection and the departing road from the guidance intersection, and a linking angle formed by an entry road towards another intersection on the searched route and a road extending from the other intersection in the same direction as the departing road.

13. The route guidance method according to claim 10, further comprising:
performing non-leading guidance so as not to lead the vehicle to the parallel road when the vehicle approaches the assistant intersection in the event that there is the assistant guidance intersection.

14. The route guidance method according to claim 10, further comprising:
performing non-leading guidance at roads along the route from the current location to the departing road of the guidance intersection, the roads in the same direction as the departing road.

15. The route guidance method according to claim 10, further comprising:
performing non-leading guidance at intersections along the route from the current location to the guidance intersection.

16. The route guidance method according to claim 10, further comprising:
performing non-leading guidance with features of the assistant guidance intersection.

17. The route guidance method according to claim 10, further comprising:
performs non-leading guidance based on a presence or absence of traffic signal lights at the assistant guidance intersection and the guidance intersection.

18. The route guidance method according to claim 10, further comprising:
performing non-leading guidance by not performing leading guidance.

19. A storage medium storing a set of program instructions executable on a data processing device, the program instructions usable to implement the method of claim 10.

20. A route guidance system for a vehicle, comprising:
means for detecting the current location of a vehicle;
means for searching for a route to a destination;
means for setting a guidance intersection based on the searched route;
means for determining whether an assistant guidance intersection exists on the searched route, the assistant guidance intersection having a parallel road which extends in the same direction as a departing road from the guidance intersection; and
means for performing guidance for leading the vehicle to the departing road when the vehicle approaches the guidance intersection after having passed the assistant guidance intersection.
